(19) United States
(12) Patent Application Publication
(10) Pub. No.: US 2007/0192144 A1
(43) Pub. Date: Aug. 16, 2007

(54) HEALTH CARE ANALYSIS SYSTEM AND METHODS

(76) Inventors: Karen L. Hauer, Eagan, MN (US); Terry L. Hauer, Eagan, MN (US); Mark S. Fisher, Stillwater, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/675,515

(22) Filed: Feb. 15, 2007

Related U.S. Application Data
(60) Provisional application No. 60/773,481, filed on Feb. 15, 2006.

(51) Int. Cl. G06F 19/00; G06F 17/00

(52) U.S. Cl. 705/3; 705/400

(57) ABSTRACT

Methods and systems for providing health care information about one or more health care providers to a health care consumer. A database stores health care information, including the costs charged by multiple health care providers for identical health care services. A consumer search module retrieves the cost information from the database based upon a health care service identification code and insurance plan input by the consumer. The search module then displays the costs charged by one or more health care providers for the health care service. The system also generates a good faith estimate of the costs associated with one or more health care services.

### CROSS-REFERENCES

This application claims priority to U.S. Provisional Application No. 60/773,481, filed Feb. 15, 2006, titled HEALTHCARE ANALYSIS SYSTEM AND METHOD, now pending and incorporated by reference in its entirety.

### FIELD

The present invention relates to systems and methods for providing health care information, and relates particularly to providing health care information regarding multiple health care providers to health care consumers.

### BACKGROUND

Changes in health care over the past several years have increasingly affected patients and the decisions they make about their health care. A benefit plan model used over the years has shielded patients from some of the more difficult health care decisions, especially decisions based upon the real cost of health care services. Many patients have participated in managed care plans provided by health maintenance organizations or other managed care providers. Instead of correlating to the actual cost of service, these plans feature monthly premiums and flat co-payments for most health care services and prescription drugs. As long as patients choose health care providers within the managed care network, patients pay the same monthly premium and flat co-payments regardless of which health care provider they choose or the actual cost of the services provided. In many cases, third party payors, such as employers or the government, have provided a health care plan as a benefit, and in such cases, an employee's or patient's primary monetary consideration is the size of the co-payment needed for the health care service or prescription drug.

Due to the influx and demand for new medical technologies and pharmaceuticals, health care costs have skyrocketed. As health care costs have risen, managed care providers have begun to pass on the increased costs to patients and third party payors. Third party payors are in turn shifting these costs onto their beneficiaries. As health care costs become an ever-increasing percentage of operating budgets, small to mid-sized corporations that used to provide these benefits are no longer able to afford the rising costs. These employers have abandoned their health care benefit plans, or at the very least, have decreased their contribution towards an employee's monthly premium. As such, health care is no longer an automatic benefit of employment, and employees are being asked to shoulder an increasing portion of the cost of their health care. To increase affordability to individual patients, health care plans are offering higher deductibles as an alternative to higher monthly premiums.

As deductibles have increased, patients have become more concerned about the costs of their health care services since more of these costs are coming out-of-pocket. Patients in these situations are no longer able to focus solely on a flat co-payment, but must instead consider the entire cost of the services. Just as with other purchasing decisions, as patients consider these high costs, they must also consider many other factors, and which are most important to them, because of their limited resources to pay for health care services. In effect, patients are health care consumers in that they are purchasing health care services in the marketplace of health care providers.

Health care consumers are now in charge of their health care decisions from both a medical and financial standpoint. Because of their limited resources, health care consumers want to receive the best value for their money. In order to make informed health care decisions, they must actively search out their options and choices to make the best decisions available for their situation. In effect, the “best value” can be expressed as an individual consumer's Patient Value Equation (PVE). For example, when patients only had flat co-payments, they tended to focus more on the level of service provided and whether access was convenient. In other words, a patient's old PVE could be expressed as Value=Service+Access+Convenience. Service could be defined in terms such as how the patient was treated; access in terms such as available appointments, accommodating appointment times, and waiting time for an appointment; and convenience in terms such as how close the provider's office is to bus lines and freeways, and the number of locations. Now that patients/health care consumers need to also consider the cost of services, they also focus more on the quality and safety of the services, in addition to other factors. This means that patients have a new PVE which can be expressed as

$$Value = \frac{Safety + Service + Access + Convenience}{Cost} .$$

Just as health care consumers are asking for more information in order to make informed health care decisions, health care providers also need to provide this information in order to attract and satisfy health care consumers. As health care services are increasingly provided through a marketplace approach based upon overall cost, health care providers can no longer take for granted that health care consumers will choose them solely because of, for example, convenient access. As such, health care providers have a need to market themselves to health care consumers in a way that provides all the information that consumers desire, and offers an opportunity to differentiate themselves from other providers. In addition, providers have a need to comply with certain price disclosure laws, which many states have implemented.

However, gathering and providing enough information to assess these important factors can be difficult. Health care providers are not used to providing cost information directly to consumers, and generally do not have comprehensive systems in place for conveying this information. Health care consumers can easily become frustrated as they attempt to solicit from multiple providers the information they need to make an informed health care decision. In many instances, consumers are only informed about health care costs in the form of an invoice after the services are provided. Health care consumers have a need for access to comparative cost information and options for certain elective services before they actually need the services so that they can compare providers and select the one which provides the most value according to their individual PVE.

As such, there exists a need for a source of health care information which fulfills the needs described above.

### SUMMARY

The present invention is directed to a method of providing health care information to a health care consumer. The method can comprise maintaining a database storing health care information, wherein the health care information can include cost information, receiving one or more health care service inputs that identify a health care service, receiving two or more provider inputs that identify health care providers, retrieving cost information associated with the health care service input and provider inputs from the database, and providing the retrieved cost information to the health care consumer. In some embodiments, the retrieved cost information can comprise the amounts that one or more health care providers charge for the same health care service. Further, the retrieved cost information can comprise the amounts that multiple health care providers charge associated with a number of health care services. The method can further comprise receiving an insurance input, verifying the insurance input, and retrieving cost information associated with the insurance input. In some embodiments, the health care service input comprises an identification code associated with the health care service. Further, in some embodiments, multiple provider amounts can be provided to the health care consumer at once. In addition, multiple provider inputs can be received simultaneously in some embodiments.

The present invention is also directed to a system for providing health care information to a health care consumer. The system can comprise a database storing health care and cost information, and a consumer search module adapted to receive at least one health care service input that identifies a health care service, receive at least two provider inputs that identify health care providers, retrieve cost information associated with the health care service input and provider inputs from the database, and provide the retrieved cost information to a health care consumer. In some embodiments of the system, the retrieved cost information can comprise the amounts that one or more health care providers charge for the same health care service. Further, the retrieved cost information can comprise the amounts that multiple health care providers charge associated with a number of health care services. In some embodiments the system can further retrieve cost information associated with an insurance input, after verifying the insurance input. In some embodiments, the health care service input comprises an identification code associated with the health care service. Further, in some embodiments, multiple provider amounts can be provided to the health care consumer at once. In addition, multiple provider inputs can be received simultaneously in some embodiments.

The present invention is also directed to a system for providing health care information, including a good faith estimate. The system can comprise a database module adapted to maintain a database storing health care information including cost information. The system can also comprise a consumer search module adapted to receive at least one provider input identifying a health care provider and a request for a good faith estimate. The system can also comprise a good faith estimate module adapted to receive at least one health care service input identifying a health care service, retrieve from the database retrieved cost information associated with the at least one health care service input, and generate a good faith estimate based upon the retrieved cost information. The at least one health care service input can comprises a procedure bundle, wherein the procedure bundle comprises a plurality of identification codes associated with a plurality of health care services. Further, the at least one health care service input can be received through an electronic form viewable in a Web browser, and the good faith estimate can be made available for viewing in a Web browser.

The present invention is also directed to a method of providing health care information, the method comprising maintaining a database storing health care information, the health care information comprising cost information associated with a plurality of insurance plans; receiving an insurance input associated with one of the plurality of insurance plans; verifying a health care consumer's participation in the one of the plurality of insurance plans; receiving at least one health care service input associated with a health care service; receiving at least one provider input associated with a health care provider; retrieving from the database retrieved cost information associated with the insurance input, the at least one health care service input, and the at least one provider input; and providing the retrieved cost information to the health care consumer.

### BRIEF DESCRIPTION OF THE DRAWINGS

FIG. 1 is a diagram of a computer network for use in some embodiments of the present invention.

FIG. 2 is a block diagram of a system according to some embodiments of the present invention.

FIG. 3 is a representation of an interface allowing access to consumer section modules in some embodiments of the present invention.

FIG. 4 is a representation of an interface for entering consumer profile information in some embodiments of the present invention.

FIG. 5a is a representation of an interface for searching health care information by specialty in some embodiments of the present invention.

FIG. 5b is a representation of an interface for searching health care information about one or more providers in some embodiments of the present invention.

FIG. 6 is a representation of an interface for searching health care information by health service description and/or service code in some embodiments of the present invention.

FIG. 7 is a representation of an interface displaying results from a search of health care information in some embodiments of the present invention.

FIG. 8 is a representation of an interface for entering employer profile information in some embodiments of the present invention.

FIG. 9 is a representation of an interface for adding members to an employer profile in some embodiments of the present invention.

FIG. 10 is a representation of an interface for viewing the payment status of an employer-member in some embodiments of the present invention.

FIG. 11 is a representation of an interface allowing access to provider section modules in some embodiments of the present invention.

FIG. 12 is a representation of an interface for viewing the account status of a provider-member in some embodiments of the present invention.

FIG. 13 is a representation of an interface for entering provider profile information in some embodiments of the present invention.

FIG. 14 is a representation of an interface for entering cost information into the provider profile in some embodiments of the present invention.

FIG. 15 is a representation of an interface allowing provider advisory members to edit market baskets in some embodiments of the present invention.

FIG. 16 is a representation of an interface allowing provider advisory members to add procedure bundles in some embodiments of the present invention.

FIG. 17 is a representation of an interface allowing access to several features for generating a good faith estimate in some embodiments of the present invention.

FIG. 18 is a representation of an interface displaying an electronic form for generating a good faith estimate in some embodiments of the present invention.

FIG. 19 is a representation of a good faith estimate generated in some embodiments of the present invention.

### DETAILED DESCRIPTION OF THE PREFERRED EMBODIMENTS

The following detailed description should be read with reference to the drawings, in which like elements in different drawings are numbered identically. The drawings depict selected embodiments and are not intended to limit the scope of the invention. It will be understood that embodiments shown in the drawings and described below are merely for illustrative purposes, and are not intended to limit the scope of the invention as defined in the claims.

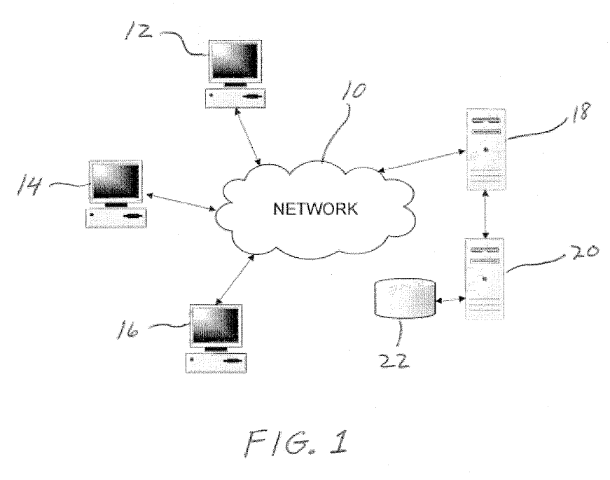

FIG. 1 shows an exemplary computer network 10 connecting one or more computing machines according to embodiments of the present invention. The network 10 may be any type of electronically connected group of computers including, for instance, the following networks: Internet, Intranet, Local Area Networks (LAN), Wide Area Networks (WAN) or an interconnected combination of these network types. In addition, the connectivity within the network 10 may be, for example, remote modem, Ethernet (IEEE 802.3), Token Ring (IEEE 802.5), Fiber Distributed Datalink Interface (FDDI), Asynchronous Transfer Mode (ATM), or any other communication protocol. Computing devices linked to the network may be desktop, server, portable, hand-held, set-top box, personal digital assistant (PDA), a terminal, or any other desired type or configuration. Depending on their functionality, the network connected devices may vary widely in processing power, internal memory, and other performance aspects. Communications within the network and to or from the computing devices connected to the network may be either wired or wireless. Wireless communication is especially advantageous for network connected portable or hand-held devices. The network 10 may include, at least in part, the world-wide public Internet which generally connects a plurality of users in accordance with a client-server model in accordance with the transmission control protocol/internet protocol (TCP/IP) specification. A client-server network is a dominant model for communicating between two computers. Using this relationship, a client computer (the “client”) issues one or more commands to a server computer (the “server”). The server fulfills client commands by accessing available network resources and returning information to the client pursuant to client commands. During this process, client computer systems and network resources resident on the network servers are assigned a network address for identification during communications between elements of the network. Communications from other network connected systems to the servers will include the network address of the relevant server/network resource as part of the communication so that the appropriate destination of the data/request is identified as the recipient. When the network 10 comprises the global Internet, the network address is an IP address in the TCP/IP format which may, at least in part, route data to an e-mail account, a web-site, or other Internet tool resident on the server. In this way, information and services which are resident on the network servers may be available to the web browser of a client computer through a domain name (e.g. www.site.com) which maps to the IP address of the network server.

FIG. 1 shows a plurality of clients 12, 14, and 16 connected to the network 10 via respective communication links. Typically, each of these clients may access the network 10 via any desired form of communication, such as via a dial-up modem connection, cable link, a digital subscriber line (DSL), wireless or satellite link, or any other form of communication. Each client may communicate using any machine that is compatible with the network 10, such as a personal computer (PC), work station, dedicated terminal, personal data assistant (PDA), or other similar equipment. The clients 12, 14, and 16 may or may not be located in the same geographical area. As will be appreciated, the term “client” generally refers to a client computer issuing commands to a server and does not at all limit the class of user that may be operating the client computer. For example, one exemplary network may include a consumer, health care provider, and/or employer each accessing resources on the same server on the network from a different client computer.

FIG. 1 further shows a server 18 connected to the network 10 to serve clients that are in communication with the network 10. Each server is typically a powerful computer or device that manages network resources and responds to client commands. As is known in the art, the servers include computer readable data storage media such as hard disk drives and RAM memory that store program instructions and data. Using such stored programs, the server 18 can run application programs that respond to client commands. As shown in FIG. 1, for example, the server 18 may run a web server application for responding to client requests for HTML pages or may manage other resources relating to web sites for various users. For example, the server 18 can communicate with a database server 20 in order to respond to client requests for information from a database 22.

As is known in the art, a number of network configurations are possible. For example, in one embodiment, the database server 20 may communicate with server 18 through the network instead of through a direct communication link. In addition, the database 22 may be hosted with a web server application on the server 18, without the need for a dedicated database server. In other embodiments, a middle level of software such as application server software may provide an interface between the web server and the database.

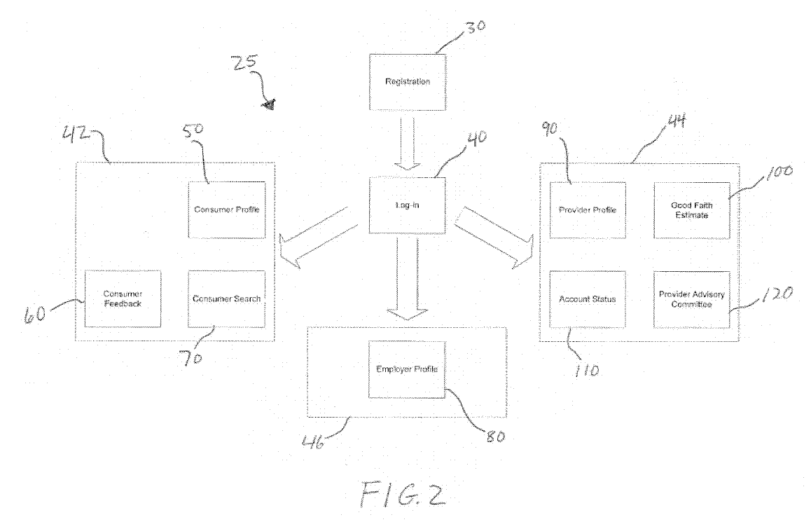

FIG. 2 shows a simplified block diagram of several components of an exemplary system 25 according to one embodiment of the present invention. The exemplary system 25 of FIG. 2 generally provides a system that facilitates an exchange of information between health care consumers, health care providers, and organizations such as employers and government agencies that have a stake in the health care services of their members. By way of overview, a registration module 30 provides an initial gateway for a user to enter the system 25. After the registration module enrolls the user as a new member, the member can gain access to the system 25 through a log-in module 40. In some embodiments, the member can proceed to one or more sections of the system. For example, the system 25 may direct the member to a consumer section 42, a provider section 44, or an employer section 46. From the sections 42, 44, 46, the member can access additional system modules. In some embodiments, a member in the consumer section, or a “consumer-member”, can access a consumer profile 50 can allow the consumer-member to store information and preferences. The consumer-member can also access a consumer feedback module 60 and a consumer search module 70 in some embodiments. A member of the employer section 46, or an “employer-member”, can access an employer profile 80 in some embodiments. In some embodiments, a “provider-member” can access modules in the provider section 44. For example, in an exemplary embodiment, the provider-member can access a provider profile 90, a good faith estimate module 100, an account status module 110, or a provider advisory committee module 120. Those skilled in the art will appreciate that in embodiments of the system, the modules and sections of the system just described can communicate with one or more databases in order to facilitate the exchange of information. For example, each module can communicate with the database 22 of FIG. 1. In addition, those skilled in the art will appreciate that FIG. 2 illustrates just one exemplary embodiment of the system 25, and that the system can be embodied in numerous configurations.

As is known, the system 25 can provide secure access to the system in a variety of ways. For example, in some embodiments, the registration module 30 can ask the new member to create a unique user name, such as an E-mail address, and a password, which the log-in module 40 can require for secure access to the system 25. In some embodiments, the registration module 30 can provide the new member a temporary password, or a link to a secure screen where the new member can create and/or change a password. In additional embodiments, the registration module 30 can require the new member to accept a set of terms and conditions and/or complete a member profile before completing registration. In some embodiments, the registration module 30 can require a new member to make a payment, for example by credit card, before gaining full access to the system 25. Further, in some embodiments, the registration module 30 can provide role-based access to the system 25 by creating section-specific memberships, which restrict access to a specific section of the system 25. For example, in one embodiment, the new member may be a consumer-member, a provider-member, or an employer-member, which is respectively granted access to the consumer section 42, the provider section 44, or the employer section 46 of the system 25. In other embodiments, the system 25 may not limit access and may not have a registration module 30 and/or a log-in module 40 at all. As used herein, the term provider-member generally refers to health care providers that are members of the system 25. The term non-member provider refers to health care providers that are not members of the system. The term provider by itself generally refers to any health care provider, whether a member or not. Those skilled in the art will appreciate that there are a variety of ways beyond those mentioned here that the system 25 can provide access for a member.

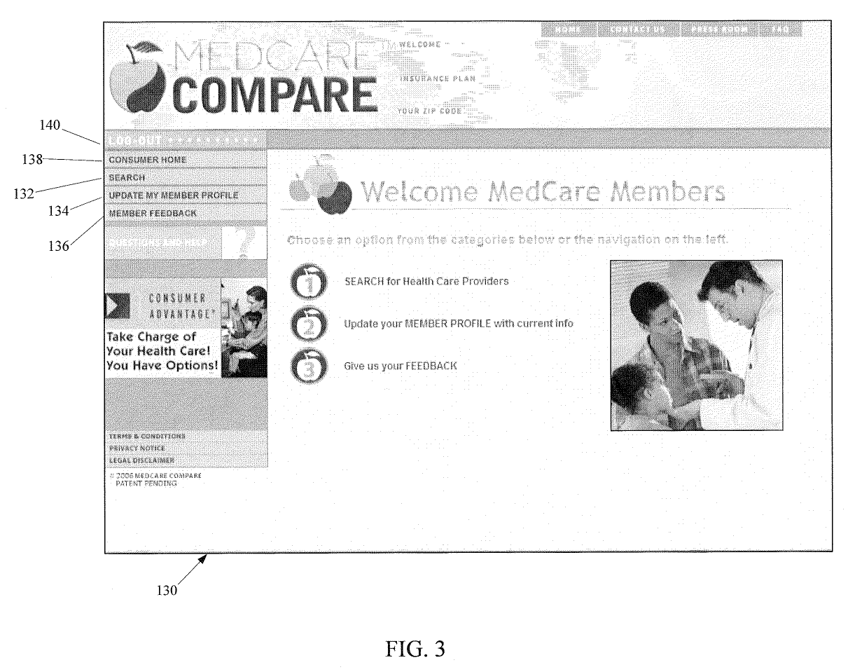

FIG. 3 shows a representation of a consumer section interface 130. In some embodiments, the system 25 can direct a consumer-member to this interface after the consumer-member logs into the system. The consumer section interface 130 can provide the consumer-member access to other modules within the system 25. For example, FIG. 3 shows a search button 132 that a consumer-member can press to be taken to an interface for searching for health care information. Member profile button 134 can direct the consumer-member to a consumer profile interface and provide a way for a consumer-member to update his or her profile as described below. The consumer feedback module (reference number 60 in FIG. 2) generates an interface when a consumer-member presses member feedback button 136. The consumer feedback interface allows the consumer-member to convey opinions and comments to an administrator of the system 25. In addition, pressing a consumer home button 138 can bring a consumer-member back to the consumer section interface 130 and pressing button 140 can allow a consumer-member to log out of the system 25, in order to protect the privacy and security of the consumer-member's information.

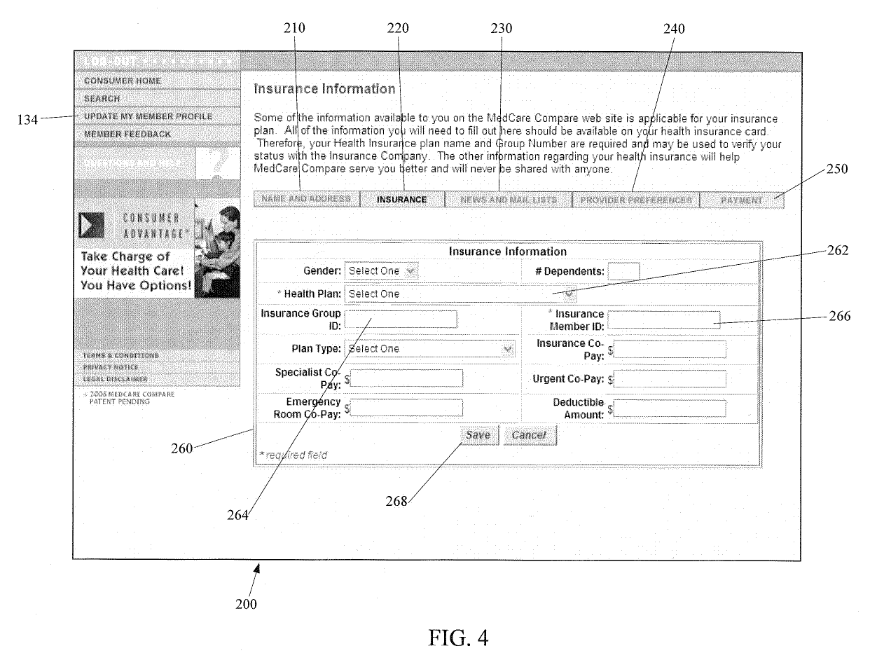

FIG. 4 shows a representation of a consumer profile interface 200 for a consumer-member to enter information into the consumer profile (reference number 50 in FIG. 2) in some embodiments of the system 25. The consumer-member can access the consumer profile interface 200 in some embodiments via the member profile button 134. The consumer profile interface 200 can generally present a number of different fields for a consumer-member to enter or input information about himself or herself into his or her consumer profile 50. In some embodiments, the system 25 can then use this information to retrieve and present relevant results to the consumer-member. In some embodiments, a consumer-member can press a name/address button 210 to enter contact information and/or modify the consumer-member's user name or password in a secure environment.

As FIG. 4 shows, a consumer-member can further press an insurance button 220 to display an insurance information box 260. The consumer-member can select a health insurance plan from the drop-down box 262, enter an insurance group ID in field 264, and enter an insurance member ID in field 266. If a consumer-member does not have an insurance plan, he or she can select a “No Insurance” option. An insurance information box 260 can allow the consumer-member to enter information about other common insurance categories. In some embodiments, the system can verify the insurance information entered by the consumer-member. For example only and not by way of limitation, the system can in some embodiments query a database of insurance participants in order to confirm that the consumer-member is a participant. The database of insurance participants can in some embodiments be managed by an insurance company. In some embodiments, the system can verify the consumer-member's participation by communicating with a third party intermediary who may verify insurance information regarding several different insurance plans offered by separate insurance companies. In some embodiments, the system's communication with the third party intermediary can be through electronic data interchange. In some embodiments of the invention, the system can limit a consumer-member's access to the system until the consumer-member's insurance information is verified.

When the system receives one or more of these insurance inputs, the system can in some embodiments retrieve health care information particularly relevant to that insurance plan (or lack of insurance plan) and the consumer-member, without any further input from the consumer-member. For example only and not limitation, the system can retrieve cost information such as contracted reimbursement rates for particular services from particular health care providers. After entering information, the consumer-member can save the information in the consumer profile 50 by pressing save button 268. In addition to insurance information, some embodiments include a news/mail button 230, which allows a consumer member to select from a number of predetermined sources of news. The system 25 can then display or e-mail the requested news to the consumer-member.

In some embodiments, the consumer-member may prefer to find information about services provided by certain health care providers. Those skilled in the art will appreciate that a health care “provider” can generally be various individuals or institutions providing health care services. For example, a consumer-member may prefer to find information about a physician, a physician assistant, a physical therapist, a clinic, a hospital, or any other person or business providing health care services. In this case, the consumer-member can register interest in a certain provider by searching for and selecting one or more preferred providers from a pre-populated list, or manually entering a provider's information, after pressing a provider preferences button 240. If the provider does not participate in the system 25, the system 25 can let the non-member provider know there are consumers interested in learning about the provider. For example, the system 25 may generate an e-mail or letter to the non-member provider indicating the number of requests for participation by consumer-members.

FIG. 4 further shows an embodiment including a payment button 250 in the consumer profile interface 200. The consumer-member can press this button in order to make a membership payment or check the expiration date of a membership. Those skilled in the art will recognize the system 25 can implement a payment transaction in a number of ways, including, but not limited to generating and mailing an invoice, charging a credit card, or debiting a bank account or other online account holding a consumer-member's funds.

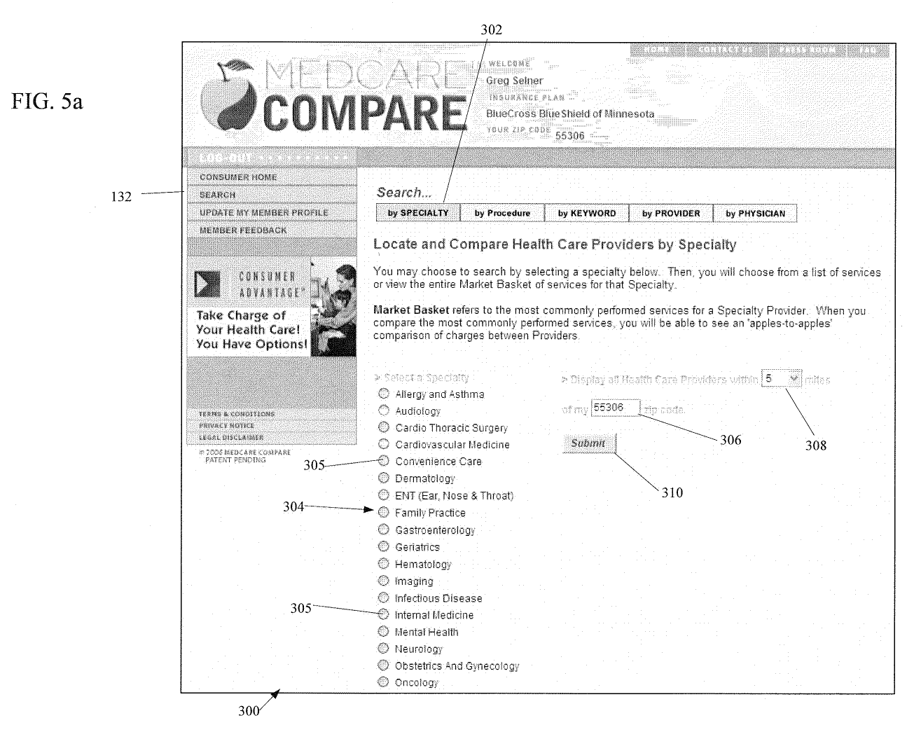

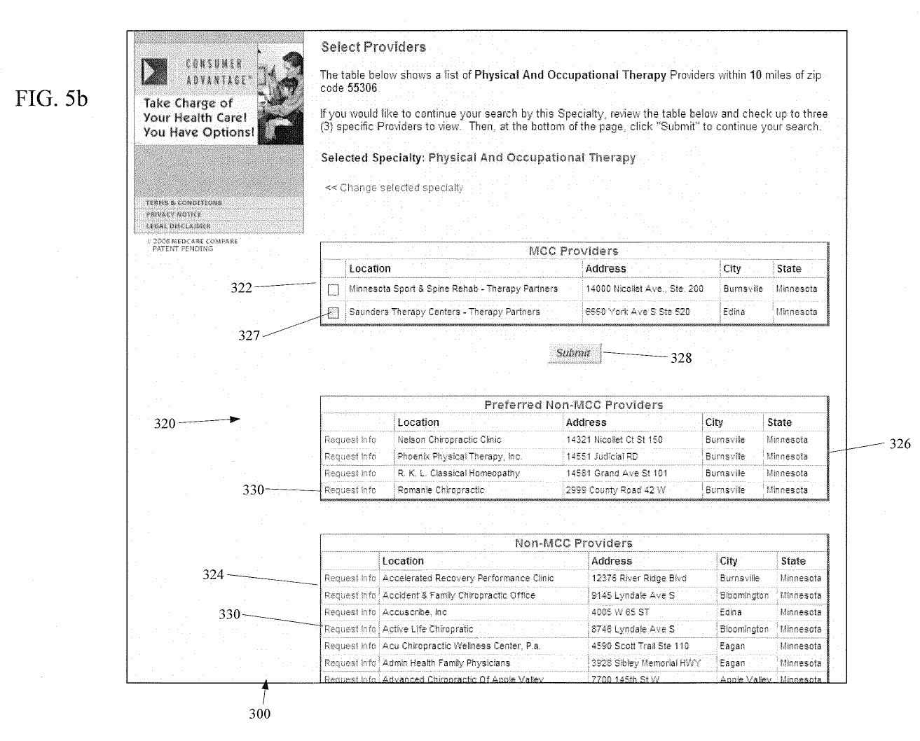

FIG. 5a shows a representation of a consumer search interface 300 for the consumer search module (reference number 70 in FIG. 2), which in some embodiments may be accessed by the search button 132. In some embodiments, the consumer search interface 300 allows a consumer-member to use the search module 70 in order to find and/or compare health care information, including cost information for health care providers, that can be stored within provider profiles or otherwise in a database such as database 22 of FIG. 1. For example, in some embodiments, the consumer-member can compare cost information such as the fees, or provider amounts, that multiple providers charge for the same health care service. Of course, it will be appreciated that the consumer-member can in some embodiments search for and display cost information and provider amounts for a single provider. In some embodiments, the search module can retrieve health care information corresponding to one or more health care inputs that the consumer-member submits through the consumer search interface 300. For example, the search module can receive a health care input based on specialty, procedure, keyword, provider, and/or physician. As used herein, the term “procedure” is equivalent with “service,” and both terms can be used to describe both a single procedure/service and a bundle of procedures/services as will be subsequently explained. FIG. 5a depicts a search by specialty in which the “by specialty” button 302 has been actuated. The search module in this embodiment can receive a specialty input when a consumer-member selects a health care specialty from a specialty list 304 by pressing one or more circles 305. The search module can provide results restricted to an area defined by a zip code entered in a field 306 and a distance entered in a field 308.

After pressing the submit button 310, the search module 70 can present the consumer-member with a list 320 of health care providers that meet the selected criteria via the consumer search interface 300 as shown in FIG. 5b. In some embodiments, the list 320 of health care providers can be divided into different categories and presented in various tables. For example, the list 320 can display a MCC Provider Members table 322, showing only provider-members, and a Non-MCC Providers table 324, showing a number of non-member providers that have not yet joined the system. In another embodiment, the list 320 can include a Preferred MCC Providers table (not shown) that lists provider-members that the consumer-member has previously identified as preferred providers. The list 320 can also include a Preferred Non-MCC Providers table 326 that lists providers that the consumer-member has identified as preferred, but who are not members of the system.

After being presented with the list 320 of health care providers, a consumer-member can select one or more of the providers in order to receive more health care information regarding the providers. For example, the search module can receive one or more provider inputs when the consumer-member selects one or more providers by checking boxes 327 and presses a submit button 328. The consumer search interface 300 can then display health care information, including cost information, about the selected providers as will be discussed shortly.

In some embodiments, the health care information regarding providers can be limited, and consumer-members may desire to request more information about certain providers. For example, the system can include cost information about services provided by provider-members, but not for non-member providers. In another example, the system can provide varying amounts of organizational information such as office hours, locations, staff directories, and the like. In some embodiments, the search module 70 can generate a form letter to a provider requesting the information the consumer-member desires. In the embodiment shown in FIG. 5b, a consumer-member can press a request info button or link 330 in order to generate a form letter requesting that a non-member provider join the system. In some embodiments the consumer-member can add personal comments to the letter. The search module 70 can allow the consumer-member to email the letter to the provider and/or print the letter in order to send or give it to the provider.

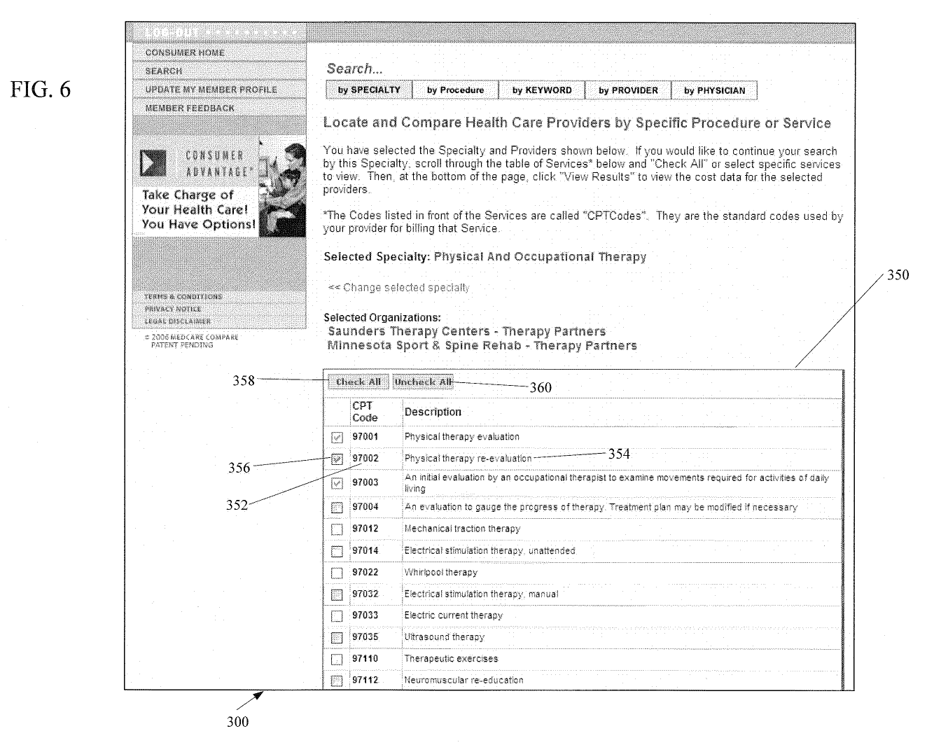

After pressing the submit button 328, the search module 70 can present a services list 350 via the consumer search interface 300 as shown in FIG. 6. In some embodiments, a specific service is described both by an identification code and a textual description. In some embodiments, the unique identification code is from a widely adopted set of standard codes for medical procedures. In a preferred embodiment, the identification code can come from the list of identification codes known by the trademark Current Procedural Terminology (CPT®) and defined by the American Medical Association. Using a standard identification code for each specific health care service is advantageous because it allows the consumer-member to easily compare identical services among different providers. Although the embodiments herein make use of identification codes defined in CPT, those skilled in the art will appreciate that any list of identification codes can be used. In some embodiments, the services list 350 displays both a CPT code 352 and a textual description 354 for each service in a specialty. The system can receive a health care service input when a consumer-member selects one or more services by checking boxes 356 or pressing a check all button 358. If the consumer-member wishes to start over, he or she can press an uncheck all button 360.

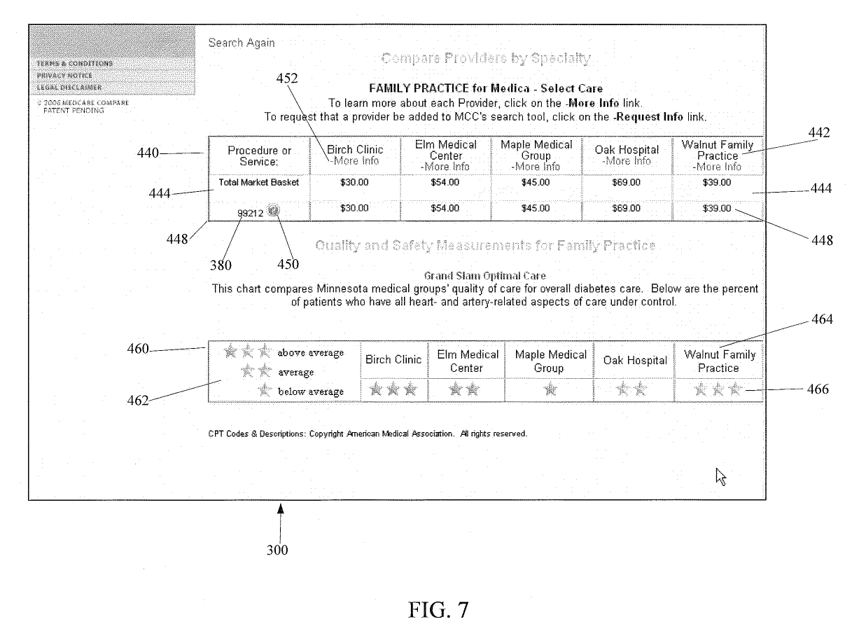

FIG. 7 shows a representation of the consumer search interface 300 displaying search results generated by the search module 70 in one embodiment. In some embodiments, the search module 70 returns information about one or more factors that a consumer-member may take into account when making decisions about his or her health care options. For example, the search results can include information according to a consumer-member's Patient Value Equation, such as costs, safety, access, convenience and/or quality. FIG. 7 shows an embodiment in which the system can retrieve cost information based on the provider input and health care service input entered by the consumer-member. In some embodiments the consumer search interface 300 can only display cost information about provider-members. In this embodiment, cost information and provider-member amounts are displayed side-by-side in the form of a cost comparison table 440. The cost comparison table 440 can list one or more provider-members 442 and various provider amounts including a cost per total market basket 444 for each provider-member, and a cost per service 448 for each provider-member. A market basket refers to the most commonly performed services in a specialty. Total market basket with reference to FIG. 7 refers to the sum of the amounts for all the services searched upon (those selected in the services list 350 in FIG. 6). In some embodiments, only the CPT code 352 is listed, along with a question button 450 which provides a description corresponding to the CPT code 352 when actuated.

In some embodiments, the cost information in the cost comparison table 440 can include provider amounts charged by each provider according to the insurance plan that the consumer-member input into his or her consumer profile. For example, the amount displayed can be equivalent to an allowed amount for the service negotiated between the provider and the company underwriting the insurance plan. In this way, a consumer-member can compare the actual out-of-pocket amount that he or she would be responsible for, taking into account the specific contracted reimbursement rates negotiated between the consumer-member's insurance company and the provider. In other embodiments, the cost comparison table 440 can list provider amounts charged by each provider as the provider would charge them to a patient without health care insurance.

Additionally, in some embodiments the consumer-member can request from a provider-member a good faith estimate of the cost for services the consumer-member is contemplating. In such an embodiment, the consumer-member can select one or more provider-members and then press a “Request Good Faith Estimate” button (not shown). The consumer-member can then complete a brief form including a description of his or her condition and the procedures/services desired. In a preferred embodiment, when the consumer-member presses a “Submit” button, the system can notify the selected provider-members via e-mail that a consumer-member has requested a good faith estimate. Once the good faith estimate has been completed, the consumer-member can receive an email notification that the requested good faith estimate is available within the secure system for the consumer-member to access, view, and/or print. In some embodiments, for example, the consumer-member can securely view the good faith estimate within a Web browser. Those skilled in the art will appreciate that other forms of notification are possible and that the system is not limited to one embodiment. For example, the system can generate a notification letter that can be sent via traditional mail to a provider-member, and/or the provider-member can traditionally mail/email the good faith estimate directly to the consumer-member.

In addition, some embodiments include a “More Info” link 452, that can allow a consumer-member to access more information about a provider. For example, the system can provide service, access, and convenience information that a consumer-member may consider as part of his or her PVE. This information can include a description of the provider's practice, a listing of individual physicians, hours and service information, and directions to various provider locations.

The quality and safety comparison table 460 depicted in FIG. 7 illustrates relative ratings for a number of health care providers 464. In this embodiment, the ratings are explained via legend 462 as “above average,” “average,” and “below average.” The rating for each provider is displayed in the corresponding rating box 466. The quality and safety of health care providers can be defined according to different standards as is known in the art. For example, in one embodiment, quality of service may be defined in terms of patient expectations, such as: 1) My doctor did what I asked, 2) I received a good explanation about my problem, 3) My problem is “fixed,” 4) My doctor followed a treatment guideline, and/or 5) No medical errors occurred. Both quality and safety of service can be defined in terms of broadly accepted and measurable standards or comparatives, such as those adopted by the group MN Community Measurement.

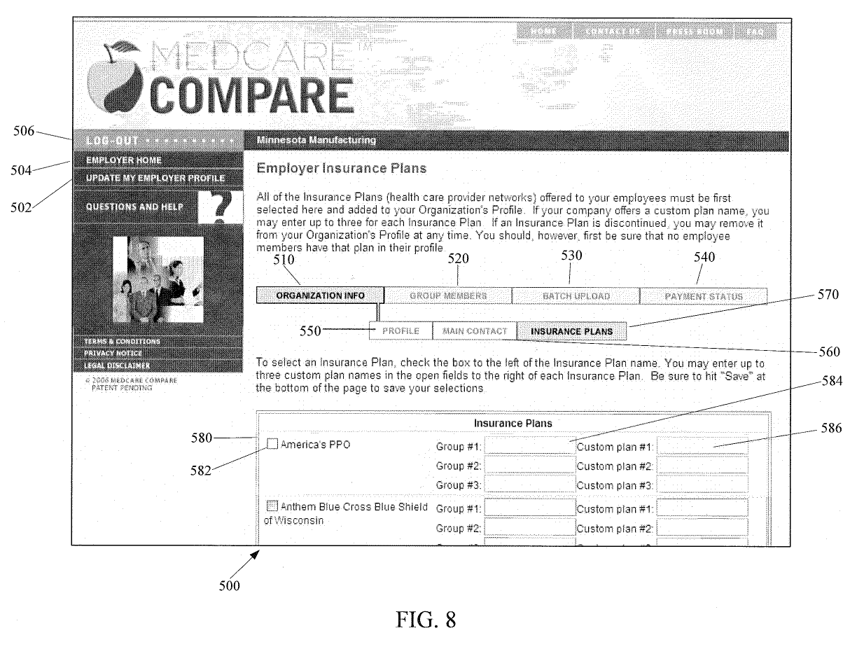

FIG. 8 shows a representation of an employer profile interface 500 in some embodiments of the present invention. The employer profile interface 500 can allow an employer-member to enter information into the employer profile (reference number 80 in FIG. 2), which in some embodiments includes a list of employees that the employer wishes to enroll in the system. In this way, an employer can provide system memberships for a number of employees, who will then be able to access the system in order to find and compare health care information. Of course in some embodiments, other types of organizations may wish to enroll members in the system. For example, an insurance company, a government entity, or other third party payor can enroll members into the system in addition to an employer. In the embodiment illustrated in FIG. 8, an employer-member can reach the employer profile interface 500 after initially registering and then logging into the system. By pressing employer profile button 502, the employer-member will be directed to the employer profile interface 500. An employer-member can also press button 504 in order to be directed to an employer section interface or button 506 in order to log out of the system.

The employer profile interface 500 in FIG. 8 allows access to several fields of information within the employer profile. An employer-member can enter organization information by pressing an organization info button 510, manually add group members by pressing a group member's button 520, upload batches of group members by pressing a batch upload button 530, and check payment status or make a payment by pressing a payment status button 540. In some embodiments, the employer profile interface 500 will direct an employer-member to enter information in a predetermined order, for example, the order just previously described. Similarly, in some embodiments, the system can require some and/or all members to enter information in a predetermined order in other sections of the system. After pressing the button 510, an employer-member can enter basic organization contact information by pressing a profile button 550. Similarly, contact information for an individual who is the organization's main contact can be entered after pressing a main contact button 560. By pressing an insurance plans button 570, an insurance plans list 580 can be presented for an employer-member to select applicable insurance plans for its members. In some embodiments, an employer-member can add an insurance plan by selecting a box 582 in front of a desired insurance plan, entering one or more group numbers in fields 584 and one or more corresponding custom plan names in fields 586, and then pressing a submit button.

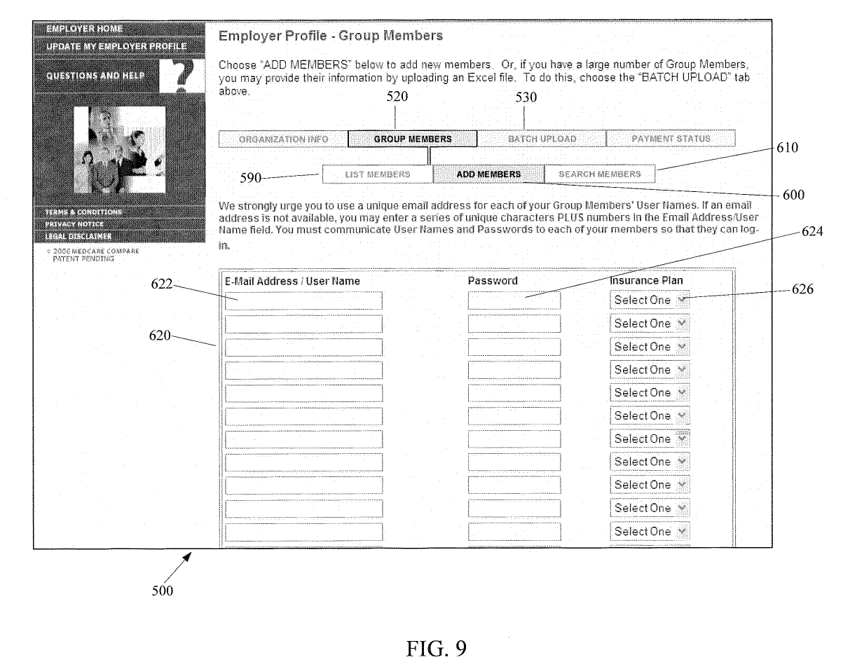

FIG. 9 shows the employer profile interface 500 with the group members button 520 actuated. With an add members button 600 actuated, an employer-member can search for individual members by pressing a search members button 610, and/or manually add individual members to the system through an add member box 620. A unique user name such as an e-mail address or other unique name can be entered into fields 622 and a corresponding password in fields 624. An employer-member can input an insurance plan or an option for no insurance from a corresponding drop-down box 626 according to the insurance plans entered into the insurance plans list (reference number 580 in FIG. 8). As with the consumer profile, the system can verify the employer's and/or employees' participation in the insurance plan in some embodiments. In other embodiments, the employer can verify the employees' participation in the insurance plan. For example, the system can require the employer to certify the insurance information.

In some embodiments, an employer-member only provides an initial password for its constituent members. The employer-member can press a “Send log-in info” button or link for each member that will e-mail the member his or her log-in user name and password. After the individual member logs into the system, he or she can change his or her password and/or user name, and when an employer-member presses a list members button 590, the member's user name and password are not displayed. This embodiment advantageously protects and secures the individual members' private health information from their employer.

The employer profile interface 500 in FIG. 9 additionally shows the batch upload button 530. By pressing the batch upload button 530, an employer-member can be guided through a process for entering multiple members into the system at one time. For example, the employer-member can be directed to download a template in which to enter member names and log-in information, which can then be uploaded into the system as a tab-delimited file. As those skilled in the art will appreciate, there are a variety of methods to provide for the batch loading of multiple members and the previous discussion is only one example.

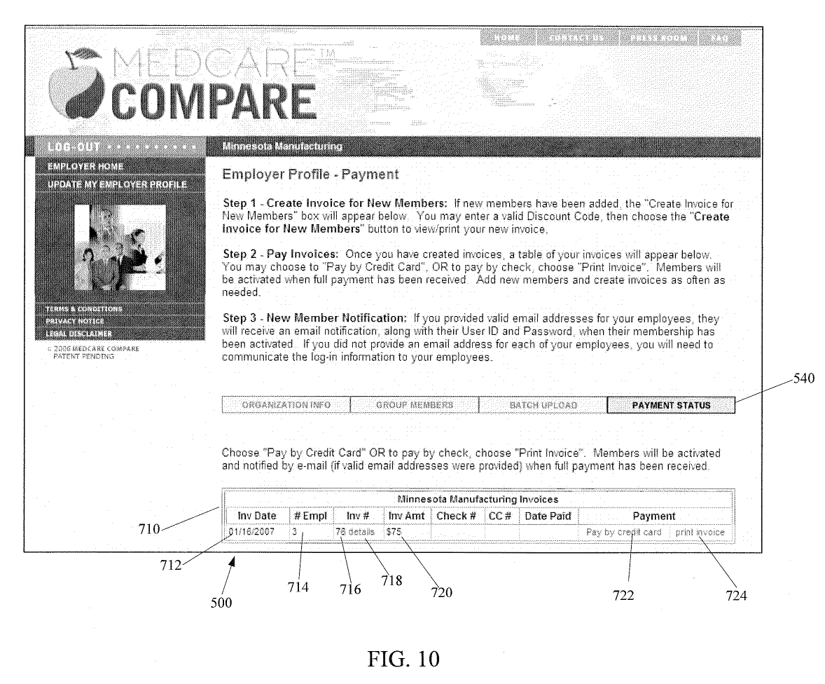

FIG. 10 shows a representation of the employer profile interface 500 with the payment status button 540 actuated. In some embodiments, whenever an employer-member adds new members to the system, those members will not be granted access until the employer-member pays an associated membership fee. After the new members are added and the payment status button 540 is pressed, the employer-member can in some embodiments press a create invoice button, which can generate an invoice that is displayed in an invoices table 710. Various information about each invoice can be presented in the invoices table 710 as is desired. For example, the invoices table 710 may display an invoice date 712, a number of employees included in the invoice 714, an invoice number 716, a details link 718, and an invoice amount 720, among many other possible categories of information. FIG. 10 additionally shows a pay by credit card link 722 that an employer-member can click in order to pay electronically by credit card, methods of which are known in the art. The employer-member can also click a print invoice link 724 in order to print a paper copy of the invoice, which can be sent to the system administrator with payment. After payment is received from the employer-member, the individual members will in some embodiments be able to access the system without making their own payment.

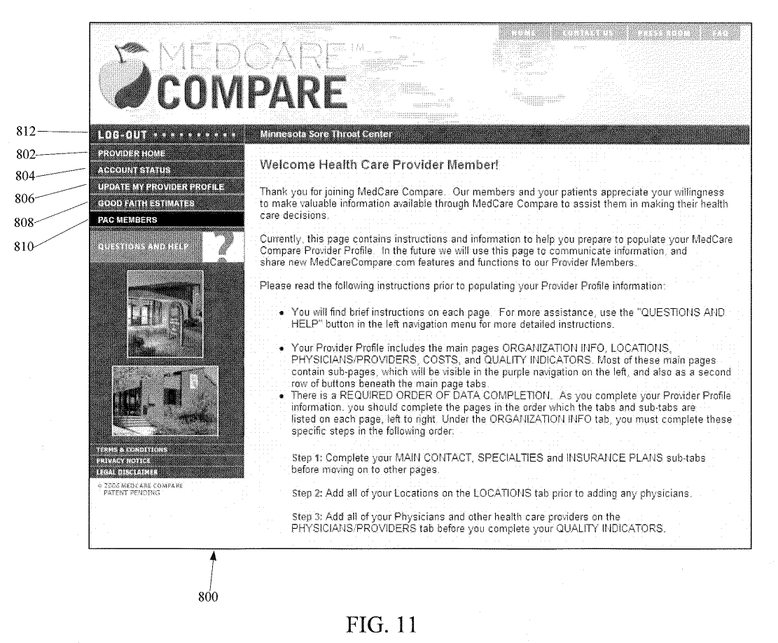

FIG. 11 shows a representation of a provider section interface 800 for the provider section (reference number 44 in FIG. 2) in some embodiments of the system. In the embodiment illustrated in FIG. 11, a provider-member can reach the provider section interface 800 after initially registering and then logging into the system. If the provider-member wishes to return to the provider section interface 800 at any time, the provider-member can press the provider home button 802. A provider-member can also press button 804 in order to be directed to an account status interface, button 806 in order to enter information into the provider profile (reference number 90 in FIG. 2), button 808 in order to access a good faith estimates interface, button 810 in order to access the PAC members interface (subsequently described), or button 812 in order to log out of the system.

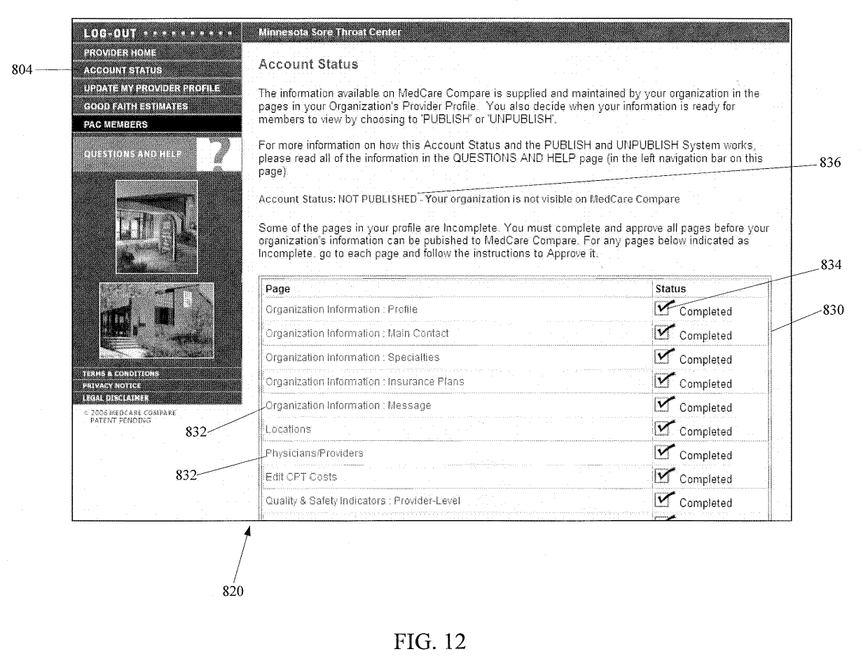

FIG. 12 shows a representation of an account status interface 820 for the account status module (reference number 110 in FIG. 2), accessible from the account status button 804. In some embodiments of the invention, the system provides a publish feature, which allows a provider-member to control when consumer-members searching the system are able to see information the provider-member has entered into the provider profile. When a provider-member initially enters information into the provider profile, the system in some embodiments will not allow the provider-member to publish any information until all areas of the provider profile have been completed. Other terms such as subsection or page can also be used to describe the distinct areas of the provider profile. The account status interface 820 can display a status checklist 830, which lists a number of pages or subsections 832 and whether their corresponding status 834 is “Completed” or “Incomplete.” In some embodiments, a publish button will appear or become active when all pages 832 have a status 834 of “Completed.” The provider-member can then press the publish button in order to make the information visible to consumer-members using the system. In some embodiments, pressing the publish button will send a request to the system administrator, who will then conduct a compliance review according to terms and conditions of use or other requirements. In another embodiment, a provider-member can make its information temporarily unavailable for viewing by choosing an unpublish function. An account status indicator 836 can display the current status of the provider profile as either Not Published or Published in some embodiments.

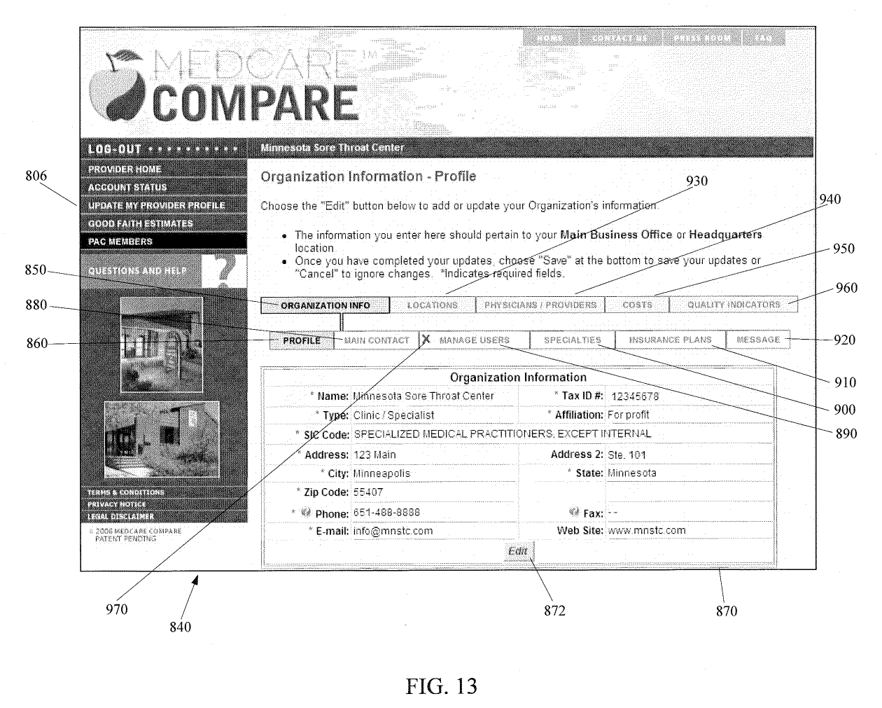

FIG. 13 shows a representation of a provider profile interface 840 for the provider profile (reference number 90 in FIG. 2). A provider-member can access this interface by pressing the update profile button 806. The provider profile interface 840 allows a provider-member to enter information into the provider profile, which in some embodiments includes cost data for specified services. A consumer-member can then compare the provider-member's information with cost data for other provider-members as previously discussed. As can be seen from FIG. 13, multiple buttons are available for accessing corresponding pages/subsections. For example, a provider-member can press an organization info button 850 in order to enter information about the provider-member into the provider profile. In the embodiment depicted, several buttons can provide access to different subsections or pages. For example, pressing a profile button 860 allows a provider-member to enter general information about the provider-member, such as contact information, into an organization information box 870. In some embodiments, information can only be entered after pressing an edit button 872.

Other buttons can be provided to allow a provider-member to enter other information as desired. For example, in the embodiment depicted in FIG. 13, a main contact button 880 accesses a main contact subsection where the provider-member can enter information about the provider-member's primary contact or representative for administering the provider-member's profile. In some embodiments, the system can allow the provider-member to set up multiple user accounts with editing rights after pressing a manage users button 890. This can be advantageous in that the provider-member can have additional people assist in managing the provider profile. For example, the provider-member can set up an account for each location. In some embodiments, the provider-member can set up one or more accounts for handling requests for good faith estimates.

Additional buttons, including a specialties button 900 and an insurance plans button 910 allow the provider-member to enter more information describing the services available and insurance plans accepted, respectively. As is known, this information could be entered in various ways, including, but not limited to selecting buttons, links, or checking boxes for selections from predefined lists, or making user-defined entries in text fields. In some embodiments, a message button 920 can allow a provider-member to enter a personalized message or other information for viewing by consumer-members in addition to the standard information requested by the system.

FIG. 13 additionally illustrates a locations button 930, through which a provider-member can enter information about the provider-member's different locations, including contact information, services available, office hours, payment methods accepted, a location description, and other pertinent information. In some embodiments, the provider-member can search a pre-populated list of provider locations, select those of interest, and add and/or edit the information already available. A physicians/providers button 940 can allow the provider-member to similarly enter information about physicians or other health care provider individuals, such as physician assistants, physical therapists, and so on. Physician/provider information can include areas of practice, location, languages spoken, whether new patients are being accepted, and other details as desired. In some embodiments, the provider-member can search a pre-populated list of physicians/providers, select those of interest, and add and/or edit the information already available.

A costs button 950 in FIG. 13 can allow a provider-member to enter cost information related to various services as will be described. A quality indicators button 960 can allow the provider-member to enter information describing the quality and safety of the services available from the provider-member, according to standards such as those discussed with reference to FIG. 7. In some embodiments, the provider profile can accept quality and/or safety indicators for different organizational levels, such as indicators for an entire provider group, a specialty, and/or specific physicians or other individuals. The quality and/or safety indicators are preferably nationally accepted criteria from accredited and/or recognized medical organizations/associations.

FIG. 13 also illustrates another aspect of the publish feature described with reference to FIG. 12. In some embodiments, an indicator 970, in this case an “X”, can appear on buttons when the corresponding pages/subsections have not yet been completed. When a provider-member is satisfied with the information entered into a subsection, an approved button can be pressed, after which the indicator 970 disappears, indicating the provider-member has approved the content for viewing by consumer-members. When the approved button is pressed in some embodiments, the status of the corresponding page will change to Completed in the account list displayed in the account status interface.

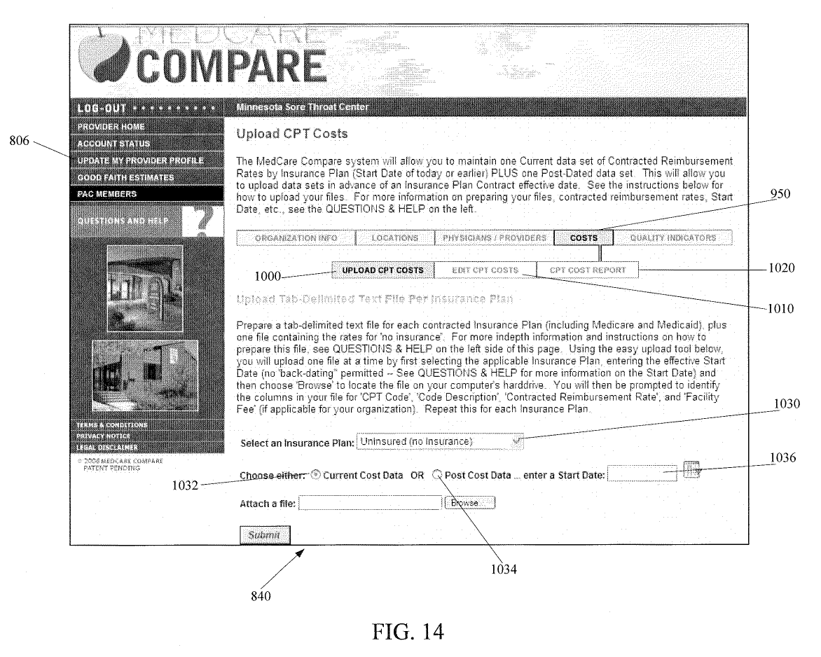

FIG. 14 shows the provider profile interface 840 with the costs button 950 actuated. In some embodiments, a provider-member can advantageously enter cost information for services in which each service is identified by the standard, unique identification code previously discussed. In some embodiments, the provider-member can enter the contracted reimbursement rates for each insurance plan accepted by the provider-member. In this way, the provider-member can allow a consumer-member with a specific insurance plan to directly compare costs with the costs per service for other provider-members. In some embodiments, the identification code for each service can comprise CPT codes as described earlier.

In the embodiment depicted in FIG. 14, a provider-member can enter cost information by uploading a cost list via an upload CPT costs button 1000. The provider-member can also manually create and/or edit a cost list via an edit CPT costs button 1010 in some embodiments. Additionally, a cost report can be generated by pressing a CPT cost report button 1020. When a provider-member desires to upload cost information, it can generally prepare the information in an acceptable electronic format, which can then be uploaded and entered into the provider profile according to the usual methods in the art. Those skilled in the art will appreciate the various ways in which this uploading can occur. As just one example, the information can be saved as a tab-delimited text file that can be uploaded and entered into the provider profile. FIG. 14 additionally shows an insurance plan drop down box 1030, which can be set according to the insurance plan for which cost information is being entered. In some embodiments, a provider-member has the option to upload cost information currently in use by selecting a current cost data circle 1032 and/or a post-dated set of service costs (circle 1034) that will take effect at a later date as entered in a start date box 1036.

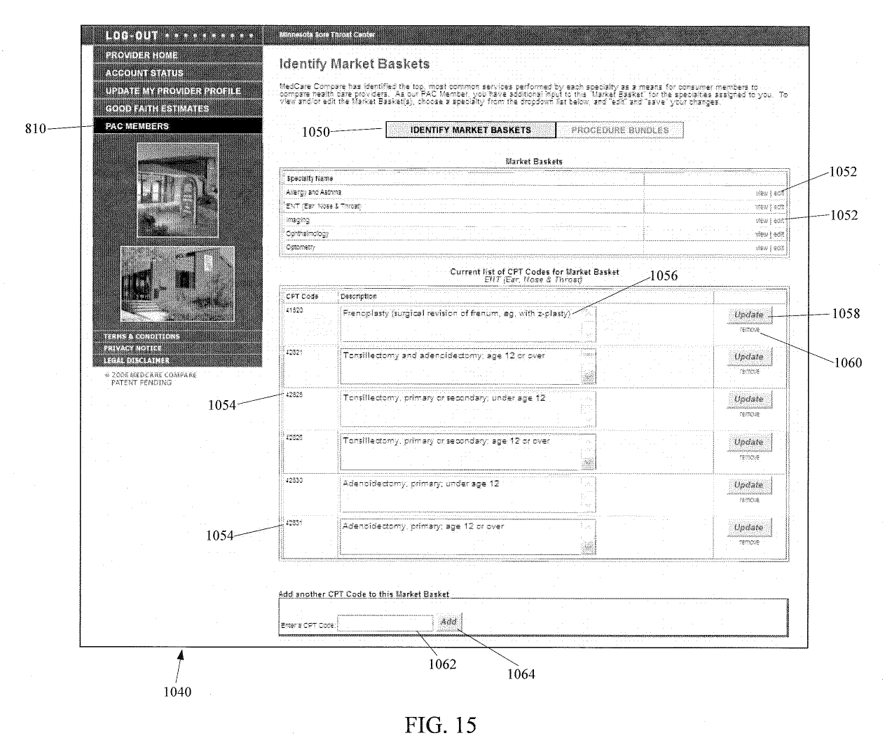

FIG. 15 shows a representation of a provider advisory committee (PAC) interface 1040 for the provider advisory committee module (reference number 120 in FIG. 2) available in some embodiments of the present invention. In some embodiments, this feature is limited to members of the provider advisory committee, who can access this interface by pressing the PAC members button 810. The PAC module can provide additional features for members of the provider advisory committee, which in some embodiments advantageously allow the PAC members to contribute to the overall effectiveness of the system. For example, by pressing an identify market baskets button 1050, a PAC member can view the procedures currently listed as part of a market basket for one of the PAC member's specialties. By pressing an edit link 1052, the PAC member can view the CPT codes 1054 for procedures in the market basket. In some embodiments, the PAC member then can edit a CPT code description in a text box 1056 and update via button 1058, or decide to remove a CPT code from the market basket by pressing link 1060. In some embodiments, the PAC member can further add CPT codes to the market basket via field 1062 and add button 1064. In this way, PAC members can enhance a specialty market basket, thus allowing consumer-members to compare health care provider-members' costs for the same procedures that the PAC member considers most commonly performed by all providers of a given specialty.

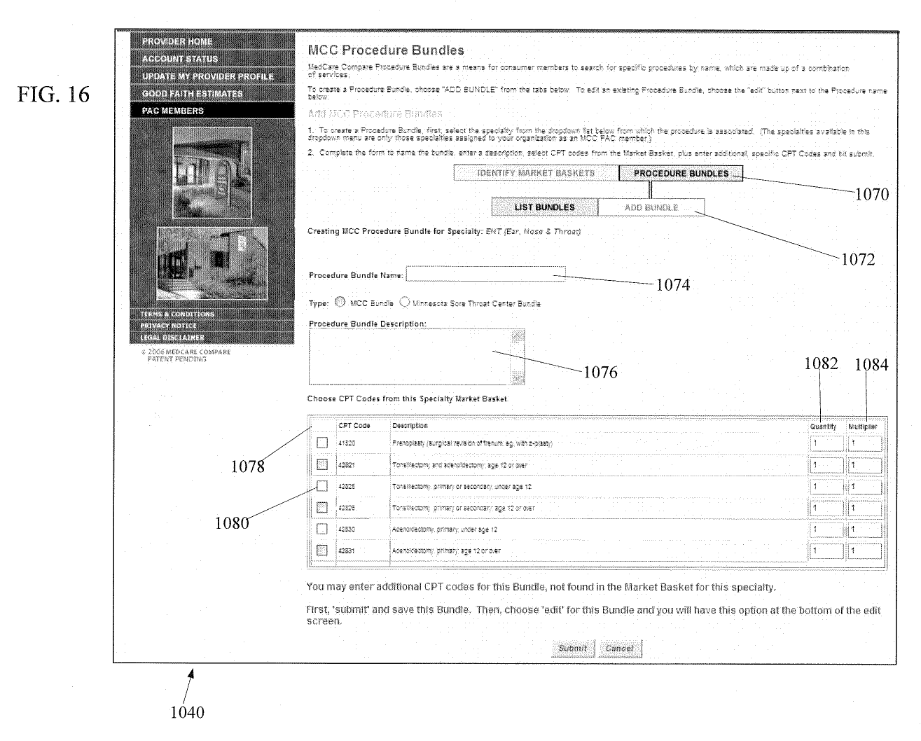

FIG. 16 shows another PAC feature available in some embodiments. By pressing a procedure bundles button 1070 and an add bundle button 1072, a PAC member can create a customized list of services that might routinely be included in a single service or procedure. The consumer-member can then search for the procedure by name and compare the total cost of the services that make up that procedure without having to know by name the individual services that might be included in a common procedure. In the embodiment depicted in FIG. 16, the PAC member can add procedure bundles to the specialties assigned to them as a PAC member. The PAC member can then enter a procedure bundle name in text field 1074, and a description of the procedure bundle in text field 1076. The PAC member can then select one or more services/procedures from the specialty market basket list 1078 by checking boxes 1080. In some embodiments, the PAC member can also add services not normally in the specialty market basket by entering a corresponding CPT code. For each selected service in the procedure bundle, the PAC member can identify a quantity 1082 and a multiplier 1084. The cost for each service can be based on the quantity 1082 and the multiplier 1084. Typically, when the same service is performed more than once during a procedure, the quantity 1082 can be used to charge that fee multiple times. When a service is performed bilaterally (two or more instances of the service at the same time) and the provider's contract only allows a portion of the rate, the multiplier 1084 can be used to adjust the amount. For example, a bilateral knee procedure bundle can include a provider performing a service on both knees of a patient at the same time. However, the provider's contract may dictate a charge of 75% of the total for both services. In this example, the quantity 1082 would be set at 2 and the multiplier would be set at 0.75.

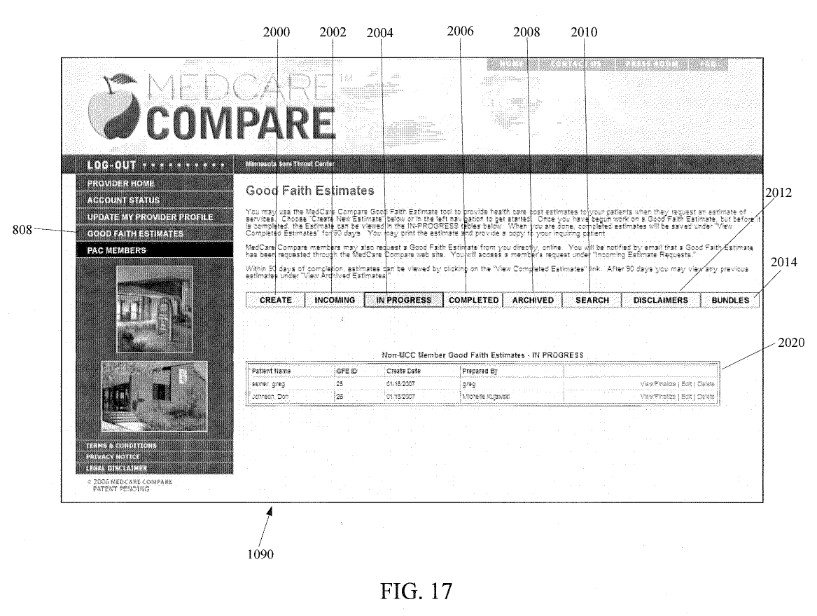

FIG. 17 shows a representation of a good faith estimate interface 1090 for the good faith estimate module (reference number 100 in FIG. 2) available in some embodiments of the system. The good faith estimate module can allow a provider-member to generate a good faith estimate (estimate) of the cost of requested services for an existing and/or new patient. In some embodiments, the good faith estimate module can receive information from the provider-member via an electronic form and then generate and/or display an electronic good faith estimate based on the information. The estimate can then be printed and/or transmitted to the patient in a variety of ways, such as by traditional mail, a secure viewing environment through a Web browser, or hand delivery. In some embodiments, a consumer-member of the system can request a good faith estimate from a provider-member as previously described. In other embodiments, the provider-member can generate a good faith estimate for patients who are not consumer-members of the system. In some embodiments, the good faith estimate module can generate estimates regardless of the membership status of the patient.

In FIG. 17, a provider-member can reach the good faith estimate interface 1090 by pressing the good faith estimates button 808. FIG. 17 shows a representation of the interface as it can appear in one embodiment of the system. Those skilled in the art will appreciate that other layouts, configurations, and embodiments are possible. In FIG. 17, a number of buttons allow a provider-member access to a variety of features within the good faith estimate module 100. By pressing a create button 2000, the provider-member can create a new good faith estimate. Pressing an incoming button 2002 can display incoming requests for good faith estimates from consumer-members of the system. In some embodiments, the system can notify the provider-member when it receives a request for an estimate from that consumer-member. Notification can be provided in any suitable way, including for example, e-mail. With an in progress button 2004 actuated, a provider-member can access a list 2020 of good faith estimates that have not yet been completed. In some embodiments, the good faith estimate module can generate separate lists of estimates for both consumer-members and patients who are not members of the system. After viewing the list of good faith estimates, the provider-member can choose to view or finalize an estimate, further edit an estimate, or delete an estimate.

Referring further to the embodiment in FIG. 17, a provider-member can view completed good faith estimates by pressing a completed button 2006. In some embodiments, completed good faith estimates may only be stored as “completed” for a defined period of time, after which the estimates are available by pressing an archived button 2008. As just one example, the good faith estimate module could archive completed estimates after ninety days. Pressing a search button 2010 in FIG. 17 can display a searching interface that allows a provider-member to search for a good faith estimate already created in the system. A disclaimers button 2012 can display options for creating a disclaimer that can be appended to the good faith estimates generated by the good faith estimates module. In some embodiments, the provider-member can choose a disclaimer from a pre-populated list or can have the ability to write a new disclaimer. By pressing a bundles button 2014, the provider-member can create a custom procedure bundle, as previously discussed, that can be included in a good faith estimate.

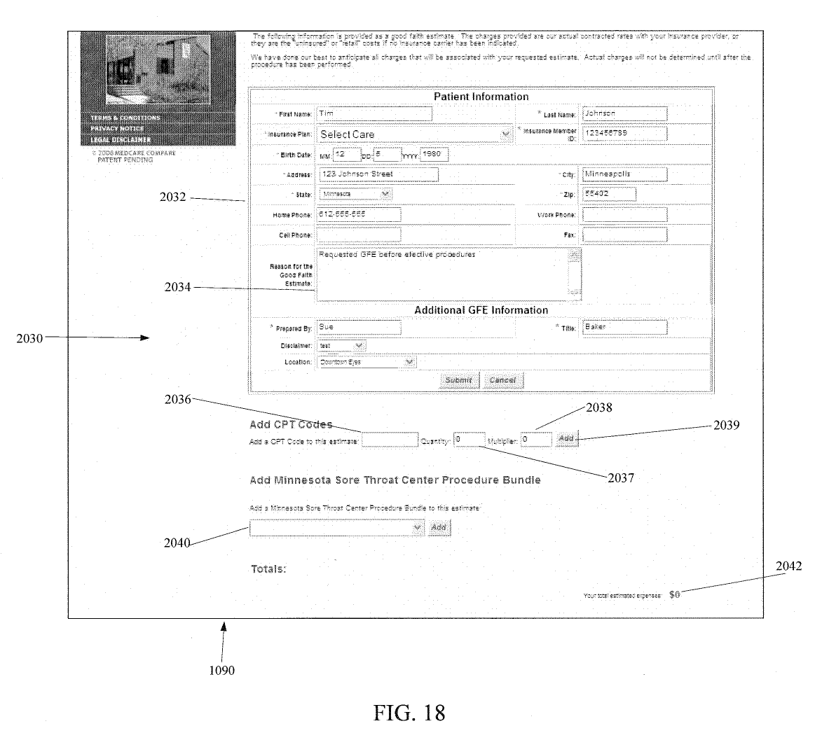

FIG. 18 shows a representation of the good faith estimate interface 1090 displaying an electronic form 2030 that can be used to generate a good faith estimate in some embodiments of the invention. In this embodiment, a provider-member can enter information about the requesting patient, including biographical information, in a patient information table 2032. In addition, a reason for the request can be entered in text field 2034. The provider-member can add specific individual CPT codes to the estimate by entering them in field 2036, entering a quantity 2037 and a multiplier 2038, and pressing an add button 2039. As depicted, a provider-specific procedure bundle can be added to the estimate via a drop down box 2040. After the provider-member completes all the requested information, the good faith estimate module can display a total estimated cost 2042 for the specified services. The provider-member can then submit or finalize the estimate and the system and print, email, or otherwise make the estimate available to the requesting party.

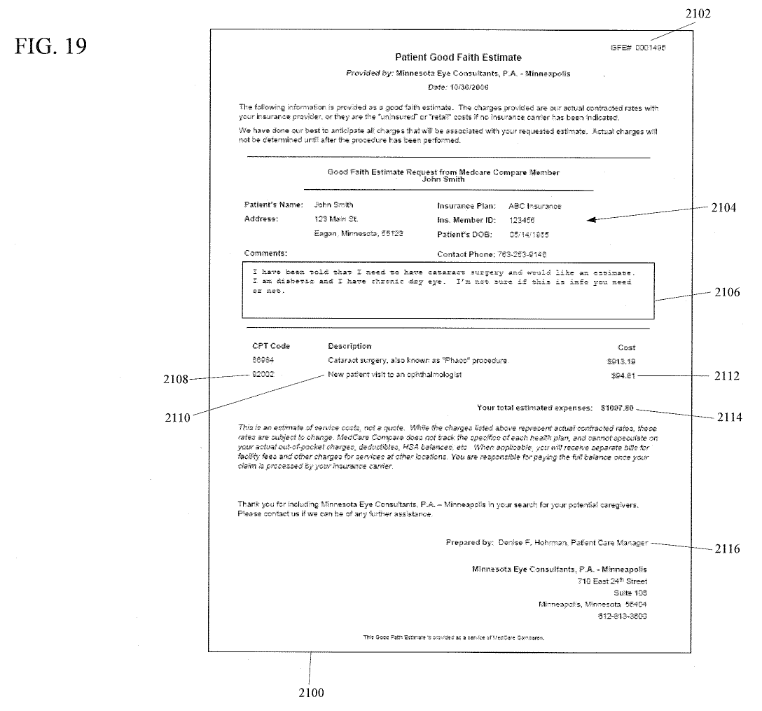

FIG. 19 shows a representation of a good faith estimate 2100 generated by the good faith estimate module in some embodiments of the invention. The good faith estimate can include an identification number 2102 for tracking it through the system. The GFE can further include patient information 2104 and comments 2106. A listing of CPT codes 2108 along with their corresponding descriptions 2110 and costs 2112, as well as a total estimated cost 2114 are preferably included as shown in FIG. 19. In some embodiments, the name of the GFE preparer 2116 can also be listed.

Thus, a HEALTH CARE ANALYSIS SYSTEM AND METHODS has been provided. While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method of providing health care information, the method comprising:
maintaining a database storing health care information, the health care information comprising cost information;
receiving one or more health care service inputs, each health care service input associated with a health care service;
receiving two or more provider inputs, each provider input associated with a health care provider;
retrieving from the database retrieved cost information associated with the one or more health care service inputs and the two or more provider inputs; and
providing the retrieved cost information to a health care consumer.

2. The method of claim 1, wherein receiving the two or more provider inputs comprises receiving the two or more provider inputs simultaneously.

3. The method of claim 1, wherein the retrieved cost information comprises a provider amount associated with the one or more health care service inputs and each of the two or more provider inputs.

4. The method of claim 3, wherein providing the retrieved cost information to the health care consumer comprises providing each provider amount simultaneously.

5. The method of claim 1, wherein each of the one or more health care service inputs comprises an identification code.

6. The method of claim 1, further comprising receiving an insurance input and wherein the retrieved cost information is associated with the insurance input.

7. The method of claim 6, further comprising verifying the insurance input.

8. A system for providing health care information, the system comprising:
a database module adapted to maintain a database storing health care information, wherein the health care information comprises cost information; and
a consumer search module adapted to
receive at least one health care service input identifying a health care service,
receive at least two provider inputs identifying respective health care providers,
retrieve from the database retrieved cost information associated with the at least one health care service input and the at least two provider inputs, and
provide the retrieved cost information to a health care consumer.

9. The system of claim 8, wherein the consumer search module is adapted to receive the at least two provider inputs simultaneously.

10. The system of claim 8, wherein the retrieved cost information comprises a provider amount associated with the at least one health care service input and each of the at least two provider inputs.

11. The system of claim 10, wherein the consumer search module is adapted to provide each provider amount simultaneously.

12. The system of claim 8, wherein each of the one or more health care service inputs comprises an identification code.

13. The system of claim 8, wherein the consumer search module is further adapted to receive an insurance input and wherein the retrieved cost information is associated with the insurance input.

14. The system of claim 13, wherein the insurance input is a verified insurance input.

15. A system for providing health care information, the system comprising:
a database module adapted to maintain a database storing health care information, wherein the health care information comprises cost information;
a consumer search module adapted to
receive at least one provider input identifying a health care provider and a request for a good faith estimate; and
a good faith estimate module adapted to
receive at least one health care service input identifying a health care service;
retrieve from the database retrieved cost information associated with the at least one health care service input; and
generate a good faith estimate based upon the retrieved cost information.

16. The system of claim 15, wherein the at least one health care service input comprises an identification code.

17. The system of claim 15, wherein the good faith estimate module is further adapted to receive an insurance input, and wherein the retrieved cost information is associated with the insurance input.

18. The system of claim 15, wherein the at least one health care service input comprises a procedure bundle, wherein the procedure bundle comprises a plurality of identification codes associated with a plurality of health care services.

19. The system of claim 15, wherein receiving the at least one health care service input comprises receiving the at least one health care service input through an electronic form viewable in a Web browser.

20. The system of claim 15, wherein providing the good faith estimate to a health care consumer comprises making the good faith estimate available for viewing in a Web browser.

21. A method of providing health care information, the method comprising:
maintaining a database storing health care information, the health care information comprising cost information associated with a plurality of insurance plans;
receiving an insurance input associated with one of the plurality of insurance plans;
verifying a health care consumer's participation in the one of the plurality of insurance plans;
receiving at least one health care service input associated with a health care service;
receiving at least one provider input associated with a health care provider;
retrieving from the database retrieved cost information associated with the insurance input, the at least one health care service input, and the at least one provider input; and
providing the retrieved cost information to the health care consumer.

22. The method of claim 21, wherein verifying the health care consumer's participation in the one of the plurality of insurance plans comprises receiving a verification from an employer of the health care consumer.

23. The method of claim 21, wherein verifying the health care consumer's participation in the one of the plurality of insurance plans comprises verifying participation through a third party intermediary.
